(19) United States
(12) Patent Application Publication
(10) Pub. No.: US 2003/0018589 A1
(43) Pub. Date: Jan. 23, 2003

(54) Method and apparatus to vary fuel prices for vehicles based on environmental and conservation considerations

(75) Inventor: Steven Paul Jones, Rochester, MN (US)

Correspondence Address: Robert R. Williams, IBM Corporation, Dept. 917, 3605 Highway 52 North, Rochester, MN, 55901-7829, US

(73) Assignee: International Business Machines Corporation, Armonk, NY (US)

(21) Appl. No.: 09/903,177

(22) Filed: Jul. 11, 2001

(51) Int. Cl. G06F 17/00

(52) U.S. Cl. 705/413

(57) ABSTRACT

A method and apparatus for determining per unit price of fuel pumped into a vehicle based on vehicle specific data stored in the vehicle is provided. The data is transmitted from the vehicle to a fuel pump computer. The fuel pump computer uses the data, along with rules provided by a regulatory agency to determine per unit fuel price. Purchase of lighter, more efficient vehicles, or vehicles producing less undesirable emissions, or vehicles capable of using alternative fuels, or hybrid vehicles, can be encouraged by providing lower per unit fuel prices for such vehicles.

### BACKGROUND OF THE INVENTION

1. Technical Field

This invention relates to sales of fuel for motor vehicles. More particularly, the invention relates to methods of pricing fuel and fuel vending systems that implement those methods.

2. Description of the Prior Art

The world contains a finite supply of petroleum reserves. These reserves are drawn upon to fuel transportation vehicles as well as to heat homes, to generate electricity, to use in the petrochemical industry and so forth. Recognizing that it is of high importance to society to use our fuel supplies wisely and efficiently there have been a number of government initiatives at all levels to encourage conservation. For example, many large cities such as Seattle, Wash., have “car pool” lanes. These lanes are reserved for vehicles with more than one person in them. The car pool lanes are usually far less congested than the other lanes and the driver is therefore able to avoid much of the stop-and-go traffic of the other lanes and get to his destination faster, thereby motivating him or her to form car pools. Cities such as Madison, Wis., have provided preferential parking for high-occupancy vehicles. Programs such as this also motivate people to form car pools. To reduce congestion and to save fuel, many cities also subsidize bus transportation or provide light rail transportation. For many people, car pooling or alternative transportation is either impractical or undesirable. Governmental agencies therefore recognize that overall improvement in vehicle fuel efficiency is in the public interest. Government has forced the automobile industry to improve fuel efficiency by enforcing fleet mileage requirements, with financial penalties for noncompliance. Other governmental influences can be seen in California's incentives to encourage the use of electrical or hybrid vehicles.

In spite of the laws, regulations, enticements, and incentives, car buyers often purchase vehicles such as Sport Utility Vehicles (SUV's), pickup trucks, or other vehicles that are notorious for poor fuel efficiency. In times when fuel is plentiful such choices are especially common. Even though these vehicles burn far more fuel than a smaller, more efficient vehicle, the driver pays the same prices for his or her fuel on a per-unit basis, such as dollars per gallon, and is therefore less motivated to purchase a vehicle that is more fuel efficient.

Therefore, there is a significant need to further motivate vehicle buyers to purchase efficient and environmentally friendly vehicles by charging lower per unit fuel prices for fuel pumped into such vehicles.

### SUMMARY OF THE INVENTION

This invention comprises a method and apparatus that provide the mechanism in which the per unit price of fuel can be made dependent upon factors deemed to be important for conservation or other ecological reasons. For example, such factors could include U.S. Environmental Protection Agency (EPA) gas mileage of the vehicle, weight of the vehicle, or quantities of undesirable emissions of the vehicle as determined by an authorized agency. Consideration for vehicles that use technologies deemed to have ecological or conservation potential such as hybrid gas/electric or gas/fuel cell could be factors as well.

This invention provides for charging per unit fuel prices that are different for different vehicles. For example, this invention provides for charging a lower per unit fuel price for vehicles that are able to go further on a unit of fuel. This invention provides for charging a lower per-unit fuel price for vehicles that are lighter in weight, and therefore less damaging to the road system. This invention provides for charging a lower per unit fuel price for vehicles that are capable of using fuels a portion of which are renewable, such as ethanol mixtures.

Another factor that can be used to adjust per unit fuel price is a vehicle's rating on emissions.

This invention teaches several ways to adjust the per unit price based upon considerations listed above. Of course, those considerations are exemplary and not limiting. Any additional factors deemed important by regulatory agencies are within the scope of this invention.

To implement this invention there must be vehicle specific data residing within the vehicle that can be read by the fuel vendor. The fuel vendor receives and uses this information to determine, at least in part, a per unit fuel price. The information received from the vehicle is used in a table lookup procedure, an equation, or a database inquiry to determine, at least in part, the per unit price of the fuel. Any method of storing such information within the vehicle is anticipated by this invention. Reading this information by the fuel vendor can be accomplished by wireless communication of any type, by connection of a data cable, by magnetic stripe reading, by infrared transmission, or by optical sensing of bar codes.

In a wireless implementation of this invention, it is important to ensure that the proper per unit price is charged to the vehicle actually being fueled at the determined per unit price. Many fuel vending sites, such as gas stations, have a number of fuel pumps. This invention provides a selector so that the driver can identify the pump selected. Once the pump has been selected, a wireless unit in the vehicle and a wireless unit in the fuel pump can communicate reliably with each other. The vehicle reports its data to the fuel vendor which determines the price per unit which that vehicle is eligible to receive. To prevent fraud, the vehicle that established the communication with the pump periodically reports to the pump the amount of fuel received for that period or the rate of fuel it is receiving. If there is substantial disagreement with the amount of fuel or the rate of fuel the pump determines it is delivering, the per unit price will change to a default, higher, price. This prevents using an efficient vehicle establishing a communication but the bulk of the fuel being delivered into a different vehicle which would not qualify for the same per unit price.

In a nonwireless implementation of this invention, such fraud is impossible if the communication link is designed according to the teaching of this invention. For example, in one embodiment, a short cable is provided near a fuel pump nozzle. A plug on the end of the cable is inserted into a jack on the vehicle; the jack being coupled to the vehicle's data storage. The shortness of cable prevents fueling one vehicle while having the jack plugged into another vehicle. If there is no jack, a default per unit price is charged.

Several other nonwireless implementations are taught by this invention. One such other implementation provides for one or more encoded magnetic strips inside the vehicle's fuel filler pipe that is read by a magnet transducer near the end of the fuel pump's nozzle as the nozzle is inserted into the fuel filler pipe. Another implementation provides for optical reading of bar codes inside the vehicle's fuel filler pipe by providing illumination and detection of the bar codes as the nozzle is inserted into the fuel filler pipe. Another implementation uses an infrared transmitter on the vehicle to send the information to an infrared receiver on the nozzle to transfer the information from the vehicle's data storage to the fuel pump.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a figure of a car being fueled by a fuel pump and communicating with the pump.

FIG. 2 is a flow chart showing the steps needed to determine a per unit price for fuel sold in an embodiment where the communication is secure.

FIGS. 3 collectively show a nozzle at the end of a fuel pump hose and how various embodiments of this invention are arranged on the nozzle, further described as follows:

FIG. 3A shows a conventional prior art nozzle which is commonly found at the end of a fuel hose.

FIG. 3B shows a first enhanced nozzle with a magnetic transducer near the end and a signal cable connecting the transducer to electronics in the fuel vendor.

FIG. 3C shows a second enhanced nozzle with a light source and a light receiver near the end, a cable to power the light, and a signal cable to connect the light receiver to electronics in the fuel vendor.

FIG. 3D shows a third enhanced nozzle with an electrical jack and a short cable portion free from the nozzle which is then connected to the nozzle and routed along the fuel hose to electronics in the fuel vendor.

FIG. 3E shows a fourth enhanced nozzle with an infrared receiver on the nozzle which receives data from an infrared transmitter on the vehicle.

FIGS. 4 collectively show a fuel filler pipe on a vehicle into which nozzles are inserted for fueling the vehicle and several how several embodiments of this invention are arranged on the pipe, further described as follows:

FIG. 4A shows the end of a conventional prior art nozzle inserted into a cutaway section of a conventional prior art vehicle's fuel filler pipe.

FIG. 4B shows a first enhanced fuel filler pipe wherein is shown a cutaway section of a vehicle's enhanced fuel filler pipe with magnetic stripe material for encoding data separated from the pipe by nonferrous material.

FIG. 4B-1 shows an end view of the enhanced filler pipe of FIG. 4B.

FIG. 4C shows a second enhanced fuel filler pipe wherein is shown a cutaway section of a vehicle's enhanced fuel filler pipe with bar code stripes on the inside of the pipe.

FIG. 4C-1 shows an end view of the enhanced filler pipe of FIG. 4C FIG. 5 shows a flow chart of steps needed when vehicle to fuel vendor communication is done using wireless means.

FIG. 6 is a block diagram showing the components and connections in a wireless embodiment of the invention.

### DESCRIPTION OF THE PREFERRED EMBODIMENT

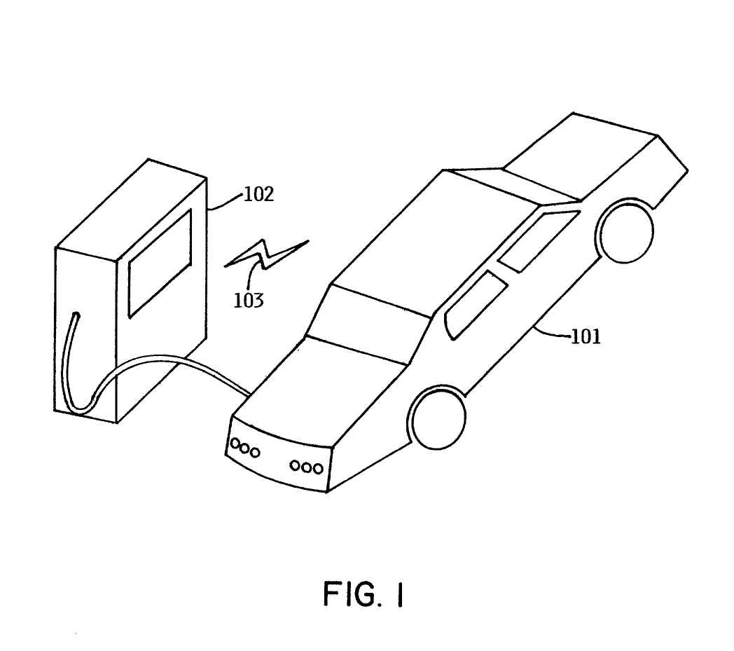

Having reference now to the drawings, FIG. 1 shows a car 101 pulled up to a fuel pump 102. Both the car 101 and the gas pump 102 are equipped with the current invention and item 103 symbolizes communication between the car 101 and the fuel pump 102. As will be taught later, said communication can be either through wireless or other means. The fuel pump 102 contains means for communicating with the car 101, and further contains a fuel pump computer that determines per unit price for the fuel based on information received from the car 101 and tables, equations, or database query processed by the computer. One skilled in the art understands that the computer may physically reside in the pump 102 itself, a service station building, or even be remotely situated. One skilled in the art will also appreciate that the computer may be a dedicated computer serving only one pump, a service station computer that serves multiple pumps, or a remote computer that may serve a large number of pumps. Such distribution or concentration of computer hardware is anticipated by this invention. Further, such computer hardware may optionally be connected to the Internet or other suitable computer network in order to change the pricing tables, equations, or database. For convenience hereinafter, the computer described in this paragraph will simply be referred to as the pump's computer. The fuel pump advantageously has a display or audio annunciator which can inform the customer of the type of fuel selected, an amount pumped, the per unit price, and information about how the per unit price was determined.

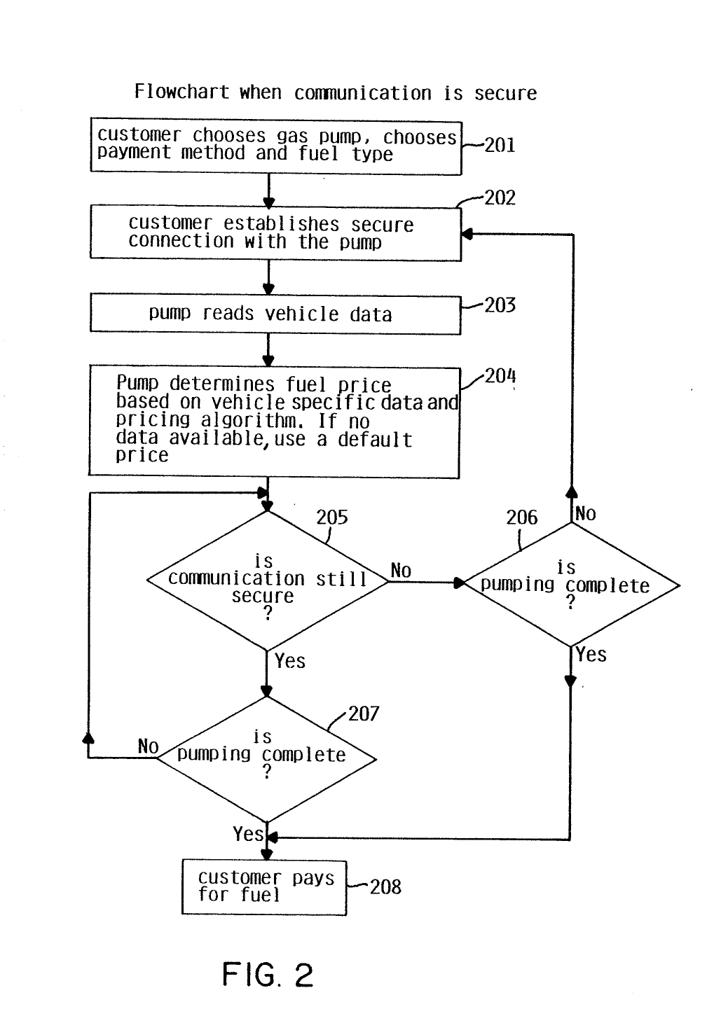

FIG. 2 shows an example flowchart that is used when there is a secure communication between the vehicle and the fuel vendor. This flowchart applies when there can be no ambiguity as to which vehicle is being fueled by a particular pump. Means to establish secure communication will be described in detail below.

In block 201, the customer chooses a fuel pump, fuel type, and payment method in a conventional manner. For example, the customer may park next to pump number 12, select regular unleaded gasoline, and payment by credit card.

In block 202, a secure connection is established between the vehicle and the fuel pump, creating an unambiguous relationship between the vehicle that will be fueled and the fuel pump.

In block 203, the vehicle sends vehicle specific data to the pump's computer. Such data could contain the “vehicle identification number” (VIN), EPA mileage rating, vehicle weight, emissions rating, information pertaining to alternative fuel capability, information pertaining to gas/electric hybrid design, or any other factors that may be deemed relevant to fuel prices by a regulatory agency.

In block 204, the pump's computer determines the per unit fuel price that the vehicle with which it has established the secure connection is eligible to receive. There are many ways the computer can determine such a price based, at least in part, on vehicle specific data and regulatory agency rules. One such way is by table lookup. Table 1 shows a table that one skilled in the art would understand how to program the pump's computer to use. In this example, the EPA Mileage is read from the vehicle and the price per gallon is obtained from the table by the pump's computer.

TABLE 1

| EPA Mileage | Price/gallon |
|---|---|
| 60 | 1.50 |
| 50 | 1.55 |
| 40 | 1.57 |
| 30 | 1.60 |
| 20 | 1.70 |
| 15 | 1.80 |
| 10 | 2.00 |
| unknown | 2.10 |

In Table 1, If the vehicle did not pass any vehicle specific data regarding EPA mileage for that vehicle, the fuel price would be $2.10 per gallon. If the EPA mileage were under 10 miles per gallon (mpg), the price would also be $2.10 per gallon. If the EPA mileage were at least 10 mpg but under 15 mpg, the price would be $2.00 per gallon. A simple table lookup using Table 1 by the computer would result in cheaper prices for a higher EPA mileage rating, up to a 60 mpg rated vehicle at which point in the example no further price reductions would result from even higher EPA mileage ratings. One skilled in the art will understand that the number of columns and rows in the table can easily be expanded to provide finer granularity in the pricing mechanism or to include more factors, such as vehicle weight, or to extend the range of the table.

Another mechanism easily programmed in the pump's computer to determine price per gallon, given data for a particular vehicle, is through use of an equation. An exemplary equation is shown below:

```
Price = A + B* (30 − EPA) + C* (W − 2000)
Where
  Price is the determined per unit price for the fuel
  A = $1.50 dollars per gallon (1)
  B = $0.01 dollars per gallon per mpg (2)
  EPA = EPA rated mileage for this vehicle (3)
  C = $0.0001 dollars per gallon per pound (2)
  W = vehicle weight in pounds (3)
(1) value established by the fuel vendor
(2) values established by regulatory agency
(3) data sent to pump's computer from the vehicle
```

In the example equation, the value for parameter A would be established by the fuel vendor based on his own business considerations, such as proximity to an interstate highway, weather, price the vendor is charged for fuel, and so on. In the example, the base price of fuel would be $1.50 per gallon, which would be charged for a “typical car” that is rated to travel 30 miles per gallon and weighs 2000 pounds.

Values for EPA and W are sent from the vehicle to the pump's computer for use in the equation.

Values for B and C would be established by the regulatory agency, depending upon what they consider to be important to encourage conservation, road wear, and the like. In the example, the price would be adjusted linearly by a penny per gallon per each mpg. For vehicles that deliver 20 mpg, each gallon of fuel would cost ten cents more than for the 30 mpg vehicle, in this example. Similarly, a vehicle that delivers 40 mpg would receive fuel for ten cents per gallon less than that charged for the 30 mpg vehicle. In the example it is also similarly shown that the per gallon price charge to vehicles over 2000 pounds goes up ten cents for each 1000 pounds of vehicle weight.

The values and mathematical weights shown in the equation are exemplary only and not intended to be limiting. Any factors deemed important by a regulatory agency can be made part of the equation. It is not necessary that a particular vehicle supply all or any of the data the equation needs, as defaults can be provided for missing data. For example, if only EPA mileage were stored in the vehicle when it was manufactured, but five years later, a regulatory agency were to decide that vehicle weight should be considered in the per unit fuel price, weight information would not be available in the vehicle specific data stored in that vehicle. That particular vehicle would supply only its EPA fuel rating and the pump's computer would use a default value for the unknown weight. Use of defaults for unavailable data is well known by computer programmers.

Upon determining the per unit fuel price, the pump should display the price in any of a number of conventional ways such as displaying the per unit price on the pump's display, voice annunciation, or printing it upon the receipt given to the customer. Display of particular factors used in the determination may also be displayed in a similar manner so that the customer knows how the price was determined.

Once the per unit fuel price has been determined in block 204, the pump begins delivering fuel into the vehicle in a conventional manner, controlled by the person doing the fueling. However, the pump computer will note in block 205 the termination of the secure connection through means described later. If pumping is complete, block 207, that is, the user turns off the pump in a conventional manner such as replacing the nozzle on the pump or turning a lever on the pump, the transaction is complete and the customer pays for the fuel purchased. It may be, however, that the customer wishes to pump some fuel into a lawn mower fuel can, or even another vehicle. In this case, block 205 and block 206 determine that a secure connection has been broken and yet pumping is not complete. In this case, the pump's computer waits for another secure connection, or provides default values if fueling begins without reception of data through the secure connection. Although it is within the technical scope of this invention that lawn mower fuel cans could have data stored, it is not expected that lawn mower fuel cans would have data stored, and would therefore receive a relatively high price due to the likely high default values. Older vehicles not equipped with such stored vehicle specific data would also be charged higher per unit prices. It is likely that regulatory agencies would, over time, ramp up the weighting on the factors in order not to abruptly make existing vehicles pay much higher fuel prices. It is within the scope of this invention that aftermarket modifications could legally equip older vehicles to report vehicle data to the pump's computer through means that will now be described which are applicable to both newly manufactured vehicles and aftermarket additions.

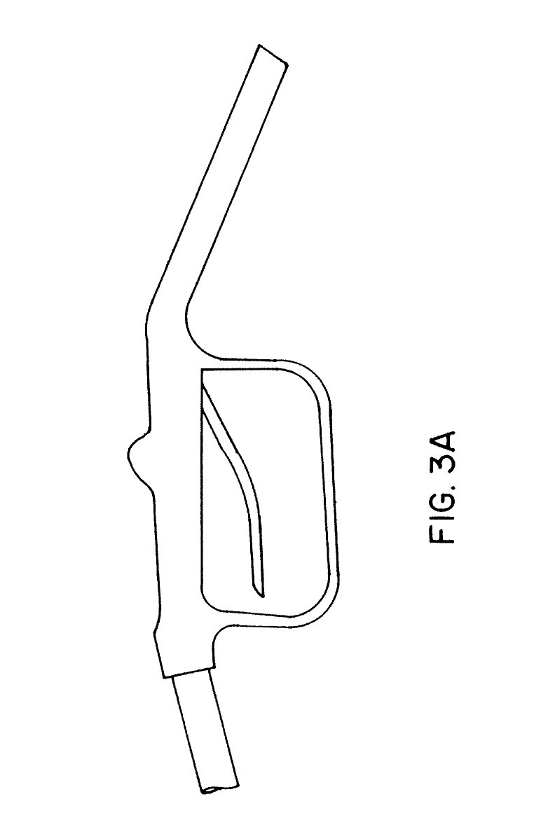

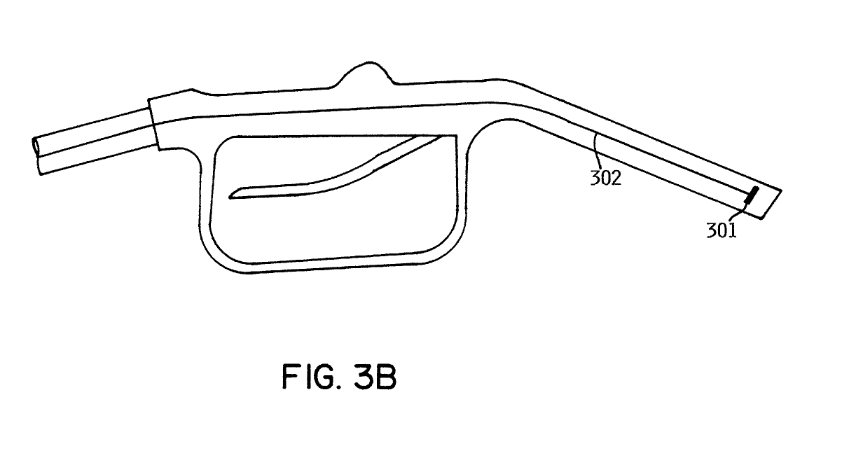

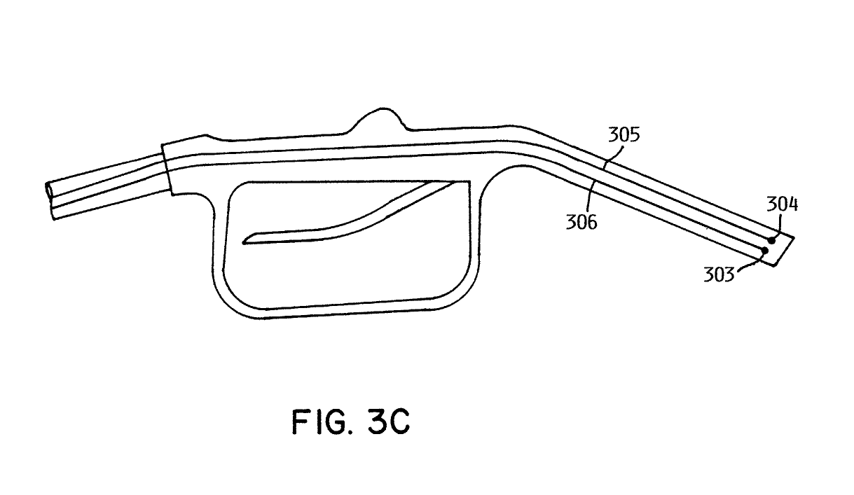

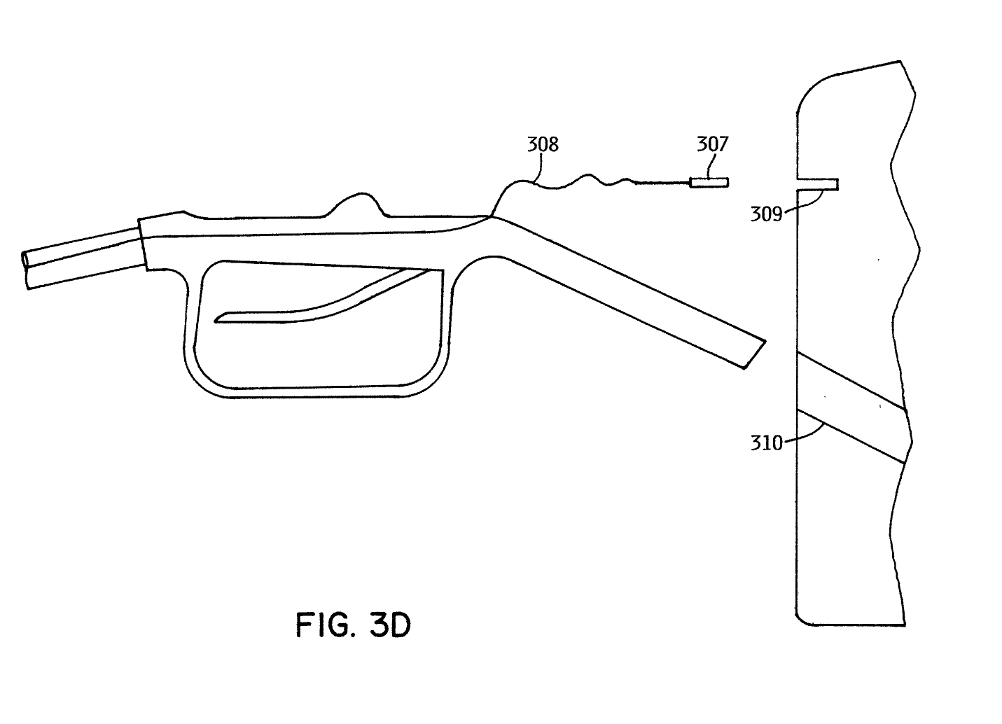

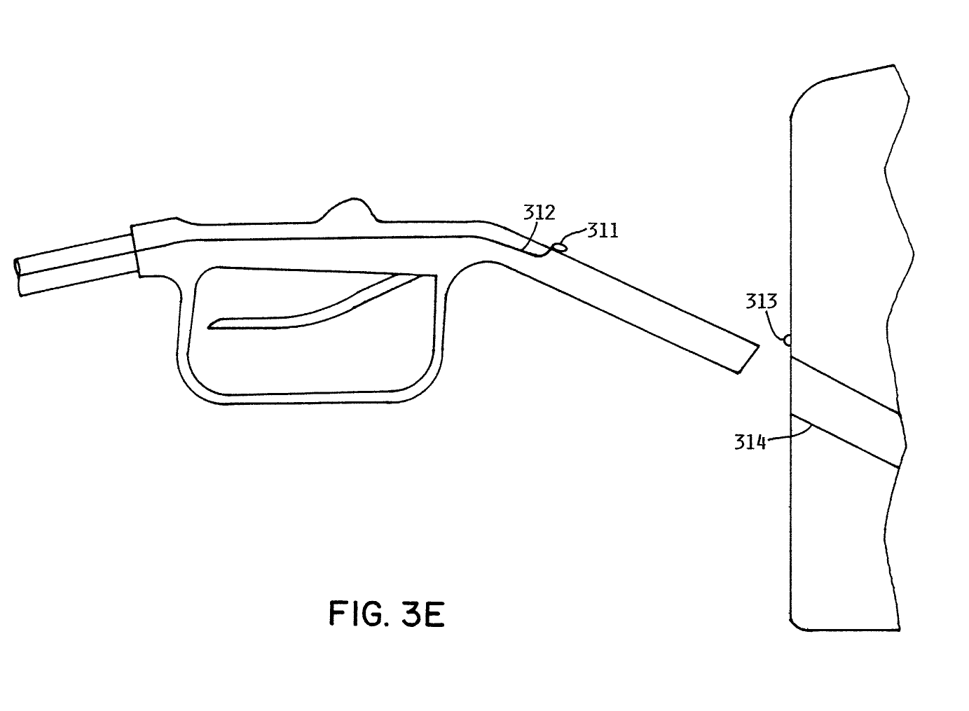

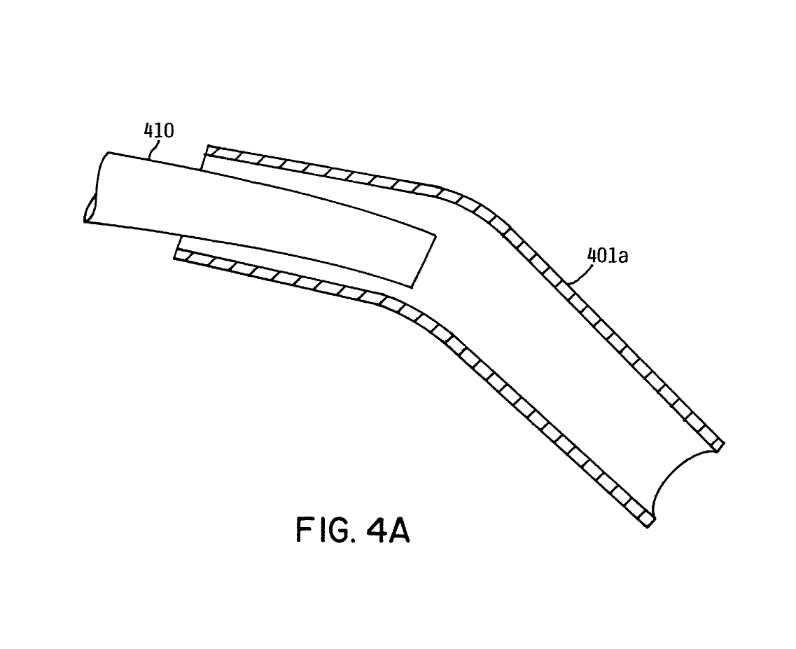

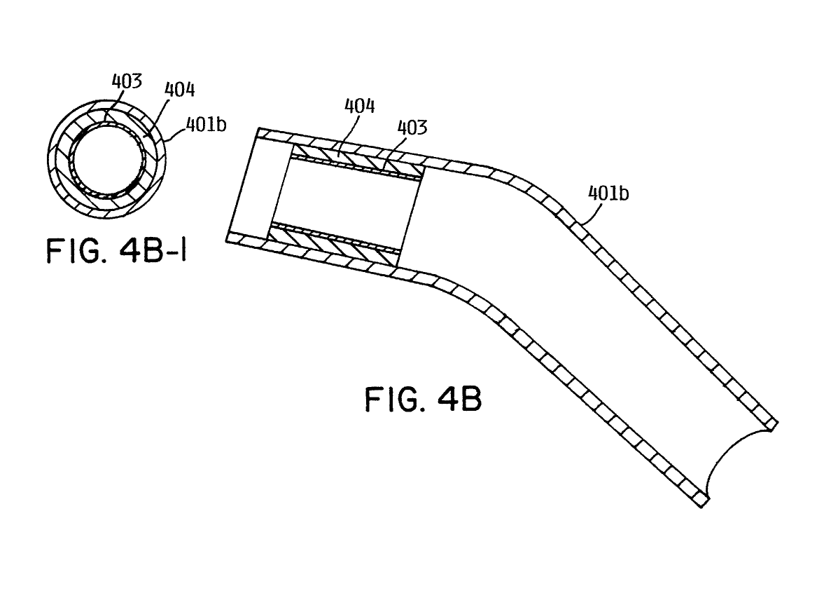

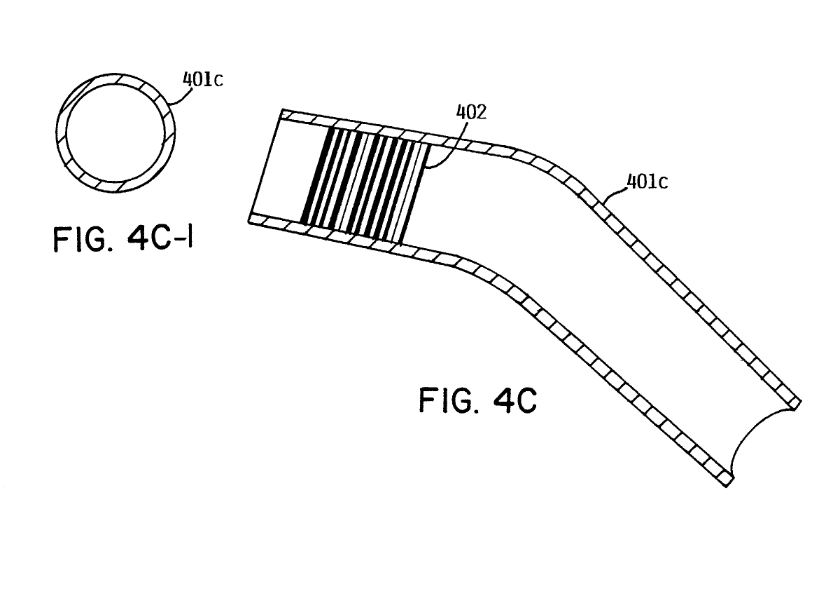

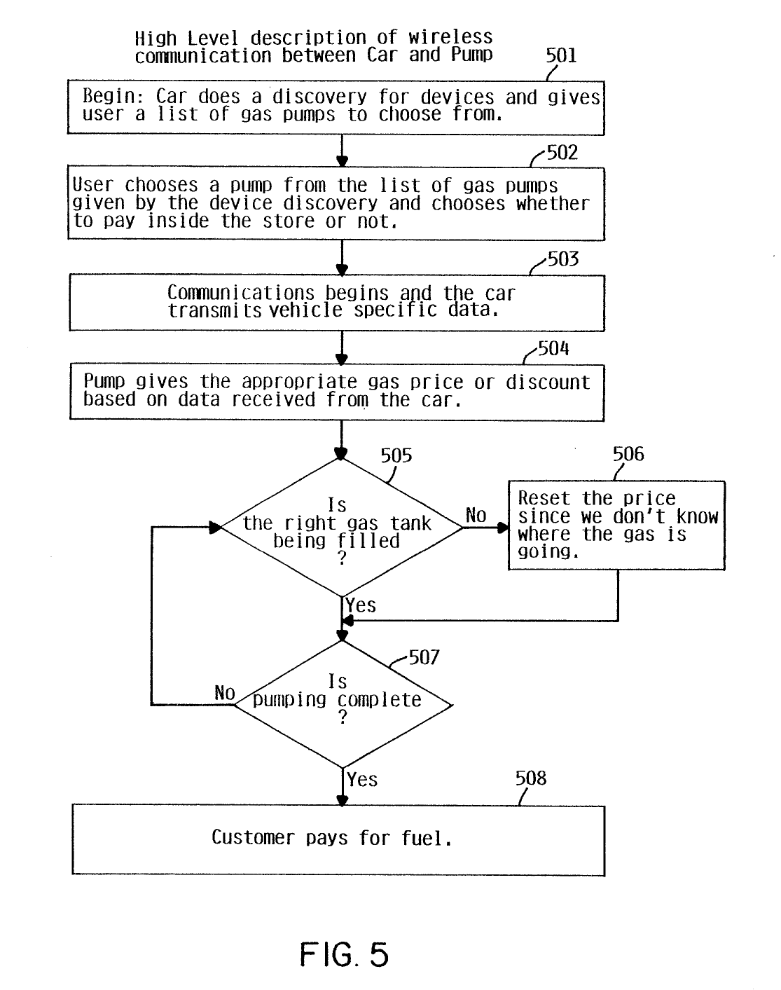

Having reference now to FIGS. 3A, 3B, 3C, 3D, and 3E as well as FIGS. 4A, 4B, 4B-1, 4C, and 4C-1, there are shown several mechanisms to establish a secure communication.

FIG. 3A shows a conventional fuel nozzle. FIG. 4A shows the end of the conventional fuel nozzle 410 inserted into a vehicle fuel filler pipe shown in cross section 401a.

FIG. 3B shows an enhanced fuel nozzle with magnetic transducer 301 placed near the end of the nozzle. Cable 302 is used to transmit signals read by transducer 301 to the pump's computer. The nozzle shown in FIG. 3B would be used in a configuration shown in FIG. 4B. FIG. 4B shows a vehicle fuel filler pipe in cross sectional view; FIG. 4B-1 shows an end view of the fuel filler pipe. Encoded magnetic strip 403 is magnetic material whereon is encoded the vehicle's data that is read by the magnetic transducer 301 as the pump nozzle is inserted into the vehicle's fuel filler pipe 401b. Encoded magnetic strip 403 can be formed as a complete cylinder of magnetic material or could be one or more strips of magnetic material that do not completely form a cylinder but which are wide enough to ensure reading of the encoded information thereon by the magnetic transducer 301 given the range of rotations at which the nozzle will be inserted into filler pipe 401b. A partial or complete cylinder 404, consisting of nonferrous material such as plastic or aluminum or copper is placed concentrically between encoded magnetic strip 403 and fuel filler pipe 401b in order that the magnetic fields are not shunted through the fuel filler pipe 401b, which is normally made of steel. The partial or complete cylinder 404 can be secured with adhesive, shrink fitting, or other suitable means. In particular, if partial or complete cylinder 404 is embodied as a partial cylinder it can be formed of a slightly larger radius than the fuel filler pipe 401b and therefore will be automatically spring loaded when inserted into the fuel filler pipe 401b. If the fuel filler pipe 401b is made of nonferrous material such as plastic, aluminum, or copper, then cylinder 404 is not needed. When the nozzle is withdrawn from the fuel filler pipe 401b, magnetic transducer 301 picks up the signal and alerts the pump's computer that the secure connection has been broken. Magnetic transducers require a certain speed past the magnetic strips to reliably read the strips. The pump may have to alert the customer when they attempt to begin fuel delivery that defaults will be used if the customer inserted the nozzle so slowly that no data was read or data checking, such as parity, cyclical redundancy checking (CRC) or other checking means indicate improper or erroneous reading has occurred. Similarly, if fueling is suspended by the user, the pump's computer may require reinsertion of the nozzle, in particular if the suspension is longer than a brief interval of predetermined duration. This would prevent the user from slowly removing the nozzle from the efficient vehicle that had been being fueled and slowly inserting it into a second vehicle. The customer, of course, can fill a lawn mower can, paying the default price as noted above. The customer can also legitimately insert the nozzle into a second vehicle, which, if so equipped, would have its data read by transducer 301 on the nozzle and would be charged a per unit price appropriate for the second vehicle.

FIG. 3C shows an enhanced nozzle with a light source 303 and a light receptor 304 placed near the end of the nozzle. Light source 303 is powered by cable 306. Signals from light receptor 304 are transmitted to the pump's computer via cable 305. The nozzle shown in FIG. 3C would be used by the vehicle fuel filler pipe shown in FIG. 4C. 401c shows a cutaway view of the fuel filler pipe. Bar codes 402 are placed near the end of fuel filler pipe 401c. These may be printed, engraved, or painted directly on the inside of the pipe. The bar coding may partially or completely cover a cylindrical area of the inside of the fuel filler pipe 401c but must cover at least the area that the light source 303 and light receptor 304 will pass by as the nozzle is inserted into the fuel filler pipe 401c. In another preferred embodiment the bar codes are printed, engraved, or painted on a cylinder or partial cylinder which is fitted inside the fuel filler pipe 401c. As with the magnetic transducer embodiment above, such a cylinder or partial cylinder can be attached adhesively, with shrink fitting, or by spring loading a partial cylinder. Data from the vehicle is read as the end of the nozzle is inserted into the fuel filler pipe 401c. The light source 303 illuminates the bar codes 402 which are then read by light receptor 304 as the nozzle as shown in FIG. 3C is inserted into fuel filler pipe 401c and the data is then sent to the pump's computer over cable 305.

FIG. 3D shows a direct electrical connection for transmission of vehicle data to the fuel pump's computer. In this embodiment, a signaling cable 308 has a jack 307 which is pluggable into a plug 309 on the vehicle. Plug 309 is electrically coupled to a data source in the vehicle. As one skilled in the art knows, such data could be a Read Only Memory (ROM), a Flash RAM memory such as are commonly used in digital cameras, or other means of storing information. Means of reading the data from these devices and transmission thereof by signaling cable are well known in the art. As shown in FIG. 3D, cable 308 is attached to the nozzle and the fuel hose except for a short portion at the end of which is jack 307. This portion is kept short to prevent plugging jack 307 into plug 309 on a vehicle which is not being fueled by the nozzle. In a preferred embodiment, none of the cable 308 is loose and jack 307 has one end attached to the nozzle with the other end being inserted into plug 309 directly as the nozzle is inserted into the vehicle's filler pipe 310.

FIG. 3E shows yet another embodiment of the enhanced nozzle. In this embodiment, infrared transmitter 313, coupled to the vehicle data storage, is placed on the vehicle near the vehicle's fuel filler pipe 314. An infrared receptor 311 is placed on the nozzle to receive data transmitted by the infrared transmitter 313. This data is then sent to the pump's computer via signaling cable 312. Preferably, the infrared transmitter is positioned near the end of the fuel filler pipe inside a fuel filler door which is not shown but is common in automobile designs for aesthetic reasons or to protect a gas cap and the end of the fuel filler pipe. In this embodiment, the transmitter and receptor need to be in close proximity to each other when the nozzle is inserted in the fuel filler pipe 314.

With reference now to FIG. 5 a flowchart applicable to unsecure communication is seen. Unsecure communication is used to denote such wireless means of communications wherein signals can be transmitted far enough as to raise ambiguity with regard to which vehicle is being fueled by a particular pump. Such unsecure wireless systems would include “Bluetooth”, which is a low cost, low power short-range radio technology. The Bluetooth specification is an open, global specification. Bluetooth is being developed as a cable replacement to connect devices. Various power embodiments of Bluetooth allow it to communicate from 5 meters to 100 meters. Other wireless systems are also well known in the art. A fueling station typically has a number of pumps and the station is likely to handle a number of vehicles at the same time. It is important that there be no confusion as to which pump is fueling which vehicle during the entire fueling transaction. It is well known in the art how to form a reliable communication between the pump and a particular vehicle. What is also required is that the pump actually fuels the vehicle for which the per unit price was determined.

Block 501 is the entry point to the flowchart. In this block the vehicle does a discovery of fuel pumps within its wireless range. This block could be initiated by the driver of the vehicle or the vehicle could be continuously seeking nearby fuel pumps. In block 501, a list of nearby pumps is created by the vehicle's wireless system and a computer in the vehicle. The computer in the vehicle receives broadcasts from nearby pumps, decodes those broadcasts, and creates the list. In block 502, the customer chooses a pump from the list. The user chooses payment method and type of fuel in a conventional manner. At block 503, the vehicle and the selected pump establish communication and the vehicle transmits its vehicle specific data to the pump's computer. At block 504, the pump's computer determines the appropriate per unit fuel price, in a manner as described above through table lookup, equation, or database query, using, at least in part, vehicle specific data received from the vehicle, and/or defaults if some or all needed data is missing or unavailable from the vehicle. At this point fueling begins. It is now important to ensure that the customer is filling the tank of the car which transmitted its data to the pump's computer and for which the pump's computer determined a per unit price. At block 505 proper vehicular fueling is constantly or frequently checked to ensure that the customer is still filling the correct tank. The vehicle's computer can periodically report to the fuel pump's computer how much fuel has been delivered to the vehicle or what the rate of fuel flow into the vehicle is. If a disparity between the fuel rate reported by the vehicle versus the fuel rate delivered by the pump exists, the price can be reset to a default as shown in 506. Simply reporting that fuel is flowing into the vehicle's tank is a preferred embodiment due to the simplicity of the technique and the unlikelihood that a customer would divert only a portion of the flow to another vehicle. However, if actual fuel rate is reported, 506 could also perform such actions as alerting the station operator as to potential fraud, or displaying to the customer that the customer's reported fuel rate appears to be incorrect and advise the customer that maintenance is required. When pumping is complete, at block 507, the customer pays for fuel in a conventional manner.

As per the secure communication embodiments, a default per unit price would apply to any sales in which required data is not received by the pump's computer from the customer's vehicle, lawn mower fuel can, or other fuel container.

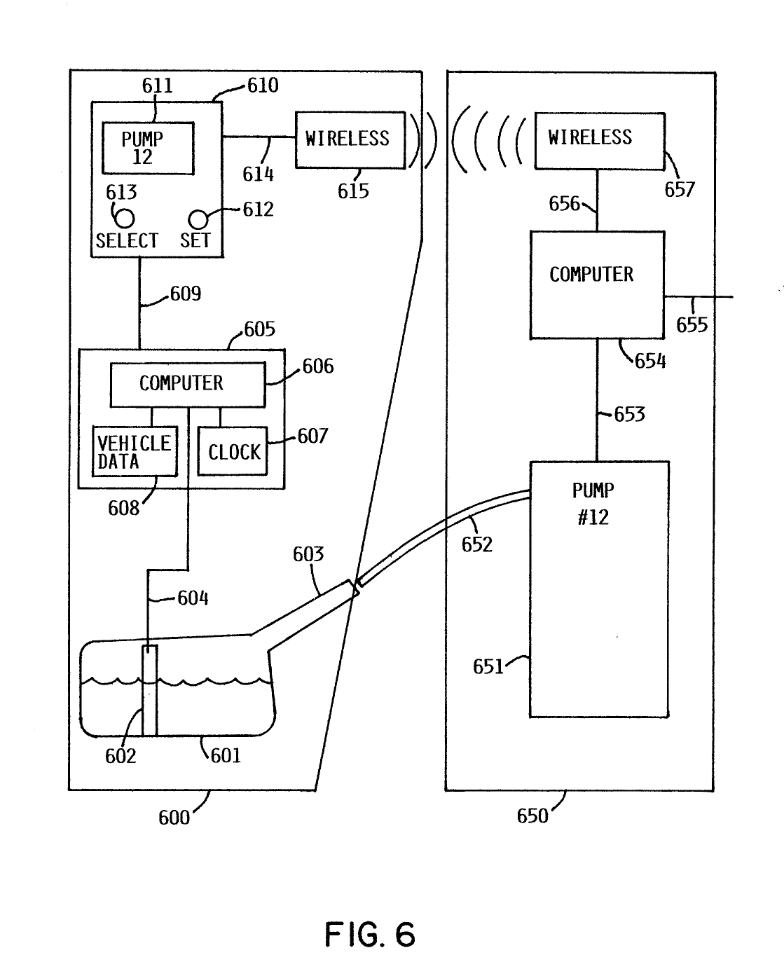

FIG. 6 shows a block diagram of a wireless system wherein measures as described above are necessary to ensure the integrity of the fueling process.

Block 650 generally shows the elements in the fuel pump apparatus. These elements include a pump 651; a pump's computer 654 which determines the per unit price using vehicle specific data received from the vehicle and computes the customer's bill based, at least in part, on that data and the amount of fuel purchased; and a wireless unit 657 which transmits and receives by wireless means. Signaling paths 653 and 656 electrically couple the pump's computer 654, the pump 651, and the wireless unit 657. Fuel hose 652 carries fuel from pump 651 to one of the nozzles shown in FIG. 3B, 3C, 3D, or 3E. As stated above, the physical location of the pump's computer 654 is arbitrary and could be in the pump itself, in an onsite building, or even at a remote location. Signal connection 655 shows a means of communication between the pump's computer and other computers. Signal connection 655 could be a signaling cable, a wireless communication link, or an Internet connection of any type. This connection can be used to change the per unit pricing mechanism, to report per unit fuel price to a station attendant, update a database with information of fuel sold and price thereof or other information desired by the fuel vendor management. The wireless unit 657 can be considered to be part of the pump's computer as simply another Input/Output (I/O) port on the pump's computer, as will be appreciated by those skilled in the art.

Block 600 generally shows the invention's relevant elements in the vehicle. Major elements in the vehicle include the fuel tank 601 and a fuel sensor 602 which measures how much fuel is in the tank; a vehicle computer unit 605 which computes fueling rates and stores vehicle specific data; and a wireless interface unit 610 which the customer uses to select a fuel pump and interfaces to a wireless transmitter/receiver 615.

The vehicle's fuel tank 601 is shown in a cross sectional view. 603 is the fuel filler pipe through which fuel is pumped into the tank 601. A fuel level sensor 602 is shown which is intended to include any means by which the fuel level in the tank is measured and reported. A vehicle computer unit 605 contains a computer 606 of any suitable type, a digital clock 607, and a means to store vehicle specific data 608. Signal conductor 604 sends fuel level data to the vehicle's computer 606. Computer 606 uses this data with clock 607 to report that the tank continues to be filled, or perhaps even the rate at which it is being filled. Computer 606 reports this information regarding continuing fueling over signal conductor 609 to the wireless interface unit 610. The wireless unit 615 sends this information which is received by the pump's wireless unit 657.

Wireless interface unit 610 is preferably placed in a position easily seen by the driver, such as a dashboard. A display 611 is provided to show the customer which pumps are available and to allow the customer to see which pump is selected. Any of a number of well known menu display and select techniques can be used once the wireless unit has discovered pump numbers within the range of the wireless. Liquid Crystal Displays (LCD), Thin Film Transistor (TFT), or Light Emitting Diodes (LED) can be advantageously used for the display, although other types of displays could be used. In the exemplary drawing of the wireless interface unit, one pump number at a time is shown, “pump 12” in the drawing. A select button 613 is used to scroll through the list of discovered pumps. Button 612 is then pushed to uniquely identify the chosen pump. Once the customer has chosen a pump, communication between the wireless unit 615 in the vehicle and wireless unit 657 in the pump can be reliably established. Other means of displaying the list and selecting a particular pump from this list are possible without leaving the scope of this invention. For example, the display could show the number of all pumps discovered, and the customer would select a pump from the list by using a keypad, a mouse, or a touchscreen.

As with the pump's computer 654 and the pump's wireless unit 657, the vehicle's wireless unit 615 and the vehicle's wireless interface 610 can be logically considered part of the vehicle's computer 606 or the vehicle's computer unit 605 as simply an I/O port on the vehicle's computer, as will be appreciated by those skilled in the art.

This invention anticipates that regulatory agencies, perhaps through authorizations to service centers, mechanics, and the like, will provide for changes in the vehicle specific data. Examples where such changes or updates would be desirable would be when the agencies decide that a new factor, for example, weight, should become a determinant in per unit fuel pricing but has not been a factor before. Adding weight to the vehicle specific data would allow weight, rather than a default, be used to determine the per unit price. In some areas, periodic emission testing is required. The testing agency would update the vehicle specific data with test results, and, perhaps date of the test. Lack of test data, or a lapsed testing date would then result in a default being used which would assume a high emission quantity. For embodiments with Flash RAM, the data can be written into the Flash RAM using known prior art. Optical bar code or magnetic stripe implementation using an insertable whole or partial cylindrical elements would require replacement of those elements. An optical bar code embodiment where the bar coding is engraved or painted directly on inside of the filler pipe would not be easily changeable.

It will be appreciated that, although specific embodiments of the invention have been described herein for purposes of illustration, various modifications may be made without departing from the spirit and scope of the invention. In particular, one skilled in the art will appreciate that computers can communicate with sensors, data storage, and communications devices in a vast number of ways, including, but limited to Direct Memory Access (DMA), system interrupts, special input/output ports, and the like.

Accordingly, the scope of protection of this invention is limited only by the following claims and their equivalents.

What is claimed is:

1. A method for selling fuel to a vehicle, wherein the method comprises the steps of:
storing vehicle specific data in the vehicle;
transmitting said data from the vehicle to a fuel pump computer; and
determining, at least partially, by said fuel pump computer, a per unit price of the fuel sold to said vehicle, using said data.

2. The method of claim 1, wherein the data comprises a value indicative of how far the vehicle is capable of going on a unit of fuel.

3. The method of claim 1, wherein the data comprises a value indicative of the weight of the vehicle.

4. The method of claim 1, wherein the data comprises a value indicative of the amount of at least one chemical composition emitted by the vehicle.

5. The method of claim 1, wherein the data comprises a vehicle identification number.

6. The method of claim 1, wherein the data comprises an indicator that the vehicle is capable of using fuel which is at least partially comprised of a renewable resource.

7. The method of claim 1, wherein the data comprises an indicator that the vehicle is a hybrid gasoline/electric vehicle.

8. The method of claim 1, wherein the step of determining a per unit price of fuel sold to said vehicle further comprises searching a lookup table for vehicle specific data in order to determine a per unit price for fuel for the vehicle.

9. The method of claim 1, wherein the step of determining a per unit price of fuel sold to said vehicle further comprises use of an equation which utilizes said vehicle specific data to at least partially determine the per unit price for the fuel sold to the vehicle.

10. The method of claim 1, wherein the step of determining a per unit price of fuel sold to said vehicle further comprises the use of a database query which utilizes said vehicle specific data to at least partially determine the per unit price for the fuel sold to the vehicle.

11. The method of claim 1, wherein the step of transmitting said data uses wireless means.

12. The method of claim 11, further comprising a step of periodically verifying that the fuel being delivered is being pumped into the vehicle from which the vehicle specific data was used to determine the per unit price.

13. The method of claim 12, farther comprising a step wherein a computer in the vehicle receives information on fuel level in a fuel tank in the vehicle and periodically transmits said fuel level or a rate of change of said fuel level to the fuel pump computer; said fuel pump computer using said transmitted fuel level or said rate of change of fuel level to verify that the per unit price is correct for the vehicle being fueled.

14. The method of claim 1, wherein the step of transmitting said data from the vehicle is by means of an electrical coupling comprising a signaling cable, a plug at an end of the signaling cable, and a jack on the vehicle to be fueled; said jack being electrically coupled to a device containing said data in the vehicle.

15. The method of claim 1, wherein the step of transmitting said data from the vehicle is by means of a magnetic transducer placed on a portion of a nozzle which is inserted into a fuel filler pipe on the vehicle; said magnetic transducer reading the vehicle data from one or more encoded magnetic strips situated in a portion of the fuel filler pipe through which the magnetic transducer passes; and wherein said data received by the fuel pump computer travels over a signaling cable between said magnetic transducer and said fuel pump computer.

16. The method of claim 15, further comprising a step wherein if fueling is suspended for a predetermined time, said nozzle must be reinserted past said encoded magnetic strips in order to resume receiving fuel at the determined per unit price.

17. The method of claim 1, wherein the step of transmitting said data from the vehicle is done by optically reading a bar code; said bar code being physically located inside the fuel filler pipe and read by a light source and a light receptor on the fuel nozzle; and wherein said data travels via a signaling cable between said light receptor and said fuel pump computer.

18. The method of claim 1, wherein the step of transmitting said data from said vehicle is by means of infrared data transmission sent from a sending unit on the vehicle to a receiving unit on the fuel nozzle.

19. The method of claim 1, further comprising the step of displaying to the customer the per unit fuel price.

20. The method of claim 19, further comprising the step of displaying an explanation of how the per unit fuel price was determined.

21. The method of claim 1, wherein the step of storing said vehicle specific data is performed under the direction of a regulatory agency after the vehicle has been purchased by the customer.

22. An apparatus for selling fuel to a vehicle, comprising:
a storage device for storing vehicle specific data within said vehicle;
a transmitter for transmitting said data to a fuel vendor; and
a fuel pump computer, which determines a per unit price for the fuel, using, at least in part, said data.

23. The apparatus of claim 22, wherein the storage device is a semiconductor memory.

24. The apparatus of claim 22, wherein the storage device is comprised of magnetic material.

25. The apparatus of claim 24, wherein the magnetic material is positioned inside a fuel filler pipe on said vehicle, and is of a substantially cylindrical or partially cylindrical shape.

26. The apparatus of claim 25, further comprising a substantially cylindrical or partially cylindrical collar positioned and affixed between said magnetic material and the inside wall of said fuel filler pipe; said collar being made of a nonferrous material and of suitable thickness to prevent shunting of magnetic fields of said magnetic material by said fuel filler pipe.

27. The apparatus of claim 26, further comprising a magnetic transducer affixed to a fuel nozzle; said transducer capable of reading information encoded upon said magnetic material as said nozzle is inserted into said fuel filler pipe and past the magnetic material.

28. The apparatus of claim 22, wherein the storage device is an optically readable bar code.

29. The apparatus of claim 28, wherein the bar code is printed, engraved, or painted on the inside wall of a fuel filler pipe on said vehicle.

30. The apparatus of claim 29, further comprising a light source and a light receptor on a fuel nozzle; said light source capable of illuminating said bar code, and said receptor capable of detecting and reading said bar code as said nozzle passes the bar code as said nozzle is inserted into said fuel filler pipe.

31. The apparatus of claim 28, wherein the bar code is printed, engraved, or painted on a substantially cylindrical or partially cylindrical collar which is positioned and affixed inside a fuel filler pipe on said vehicle.

32. The apparatus of claim 31, further comprising a light source and a light receptor on a fuel nozzle; said light source capable of illuminating said bar code, and said receptor capable of detecting and reading said bar code as said nozzle passes the bar code as said nozzle is inserted into said fuel filler pipe.

33. The apparatus of claim 22, wherein said transmitter is wireless.

34. The apparatus of claim 33, further comprising a fuel sensor in the vehicle; a computer in the vehicle which is electrically coupled to and which periodically reads fuel quantity information from said fuel sensor; said computer in the vehicle further being coupled to a wireless interface unit which controls a first wireless unit in said vehicle; said first wireless unit being in communication with a second wireless unit on a fuel pump; said second wireless unit being electrically coupled to said fuel pump computer; said fuel quantity information transmitted from said computer in the vehicle through said wireless interface unit to said first wireless unit, and from said first wireless unit to said second wireless unit, and from said second wireless unit to said fuel pump computer.

35. The apparatus of claim 22, wherein the transmitter comprises an infrared transmitter on said vehicle and an infrared receptor attached to a fuel pump nozzle.

36. The apparatus of claim 22, wherein said fuel pump computer contains a program in a memory; said program, when executed by said fuel pump computer, being capable of determining a per unit price of fuel sold to the vehicle, using some or all of said vehicle specific data, and at least one rule authorized by a regulatory agency.
